(19) United States
(12) Patent Application Publication
(10) Pub. No.: US 2002/0174264 A1
(43) Pub. Date: Nov. 21, 2002

(54) System and method for obtaining driver software and documentation for a detected hardware and software configuration

(76) Inventors: David Fuller, Austin, TX (US); Brian Sierer, Austin, TX (US); Daniel Simpson, Cedar Park, TX (US)

Correspondence Address: Jeffrey C. Hood, Conley, Rose, & Tayon, P.C., P.O. Box 398, Austin, TX, 78767, US

(21) Appl. No.: 09/860,877

(22) Filed: May 17, 2001

(51) Int. Cl. G06F 9/00; G06F 9/46

(52) U.S. Cl. 709/321; 717/176

(57) ABSTRACT

A system and method are described for automatically detecting devices or instruments connected to a host computer system and obtaining and installing driver software for the devices or instruments, including driver software for traditional instruments, e.g. an oscilloscope, connected to the host computer system via an external bus. The method may also include automatically detecting particular software applications installed on the host computer system and obtaining and installing driver software intended for use with the installed software applications. Also, a system and method for automatically detecting devices connected to a host computer system and/or detecting software applications installed on the host computer system and automatically obtaining documentation related to the connected devices and installed software applications. A first computer may provide information regarding detected hardware and/or software to a server computer. The server computer may then determine appropriate driver software and/or documentation to provide based on the received information.

### FIELD OF THE INVENTION

The present invention relates to the field of computer-based systems, such as instrumentation, test and measurement, and industrial automation systems, and more particularly to a system and method for automatically detecting a hardware and/or software configuration of a computer system and obtaining driver software and documentation related to the detected configuration.

### DESCRIPTION OF THE RELATED ART

Computer systems are used to interact with physical devices or instruments in many fields, including the fields of instrumentation, process control, industrial automation, simulation, machine vision, and multimedia among others. For example, a computer system may interact with instruments to measure and/or control various types of systems. These systems may include any of various types of physical, mechanical, electrical, chemical, or thermodynamic elements, among others, or some combination of such elements. Exemplary systems include: an engine or an engine component, a device in motion, a chemical reaction, a petroleum refining process, a room maintained at a setpoint temperature, a system of liquids flowing among different tanks, etc.

In an application such as a measurement/control application, a computer system may interact with one or more sensors/transducers operable to sense one or more variables of a system and output a signal based on the variables. The sensors/transducers may comprise any of various types of devices or combinations of devices operable to sense the variables of interest and produce output signals based on the variables. The signals produced by the sensors/transducers are most typically an electrical signal, e.g., a voltage or current, but may also be any of various other types of signals. In various applications, the computer system may also interact with one or more control devices/actuators, e.g., to provide control signals affecting a system. In some cases, a single instrument may serve as both a sensor and a control device.

Many standards related to instrumentation devices and other hardware devices have been developed. Devices may conform to one or more of these standards, e.g., depending on the function of the device and the environment or type of computer system with which the device is intended to be used. For example, some instrumentation devices conform to a standard enabling the device to be plugged into a slot in a host computer, such as a PCI slot of a PC. Other (typically larger) instrumentation devices may conform to a standard enabling the device to function externally from the host computer and communicate with the host computer via an external bus.

One example of an external bus enabling a host computer to communicate with external instruments is the General Purpose Instrumentation Bus (GPIB). GPIB is a widely recognized and used method for communicating with scientific and engineering instruments. Many stand-alone general-purpose instrument makers include GPIB interfaces in their products. Many specialist market instrument makers also rely on GPIB for data communications and control. GPIB interfaces can be connected to host computers by means of plug-in boards (e.g. ISA, PCMCIA, NUBUS), serial (e.g. RS232) and other cabled parallel or serial interfaces.

Another instrumentation standard in common use is VXI. The VXIbus was developed to add a standardized set of instrumentation capabilities to the already popular VMEbus. VXI is used in many different applications ranging from test and measurement and ATE, to data acquisition and analysis in both research and industrial automation. Although some VXI systems today are purely VXI, many users are migrating to VXI by integrating it into existing systems including GPIB instruments, VME cards, or plug-in data acquisition (DAQ) boards. A VXI system can be controlled with a host computer using the high-speed Multisystem eXtension Interface (MXI) bus interface or GPIB. The PXI bus is another instrumentation standard in common use that provides similar advantages to VXI. although in a smaller form factor and at reduced cost.

Along with the wide array of hardware devices available for use, many different software applications specialized for developing instrumentation, test and measurement, and industrial automation applications are also available. Using such applications, a developer can create a custom program to interact with a device or system. These software applications may support substantially different programming models. For example, one such application, LabVIEW, supports the development of graphical instrumentation programs, wherein data and/or control flow of a program may be defined by a block diagram including interconnected nodes. Another such application, LabWindows/CVI, supports the development of C instrumentation programs.

As the number and types of available hardware devices constantly increase, and the number and types of available software applications for use with these devices also continue to increase, users can often be overwhelmed by the task of appropriately configuring their system to interact with devices connected to the system. For example, driver software is often necessary for device communication. When connecting a new device to a computer system, installation of the appropriate driver software often requires the user to perform a separate step. It would be desirable to automate the process of driver software installation, including for traditional standalone instruments, such as oscilloscopes. Also, driver software updates often become available after driver software has been installed. It would be desirable to automatically update driver software as updates become available. Also, the necessary driver software can depend on which software application(s) will be used to communicate with an instrument (or to create programs that communicate with the instrument). Thus, it would be desirable to enable automatic installation of the appropriate driver software, based on the software applications installed on the host computer.

Another problem that users face is the task of learning to efficiently use their software applications to communicate with the devices connected to their computer systems. Although knowledge bases with information related to this task may exist, the knowledge bases typically also include a vast amount of other information which the user is not interested in. Searching for the relevant documentation can be a difficult and time-consuming task. Thus, it would be desirable to automatically provide users with documentation related to the hardware and software configuration of their computer systems, such as example programs illustrating how to use the installed software to communicate with the connected instruments, white papers related to the hardware and/or software, etc. Furthermore, it would be desirable to provide users with such documentation without requiring the users to manually specify the hardware or software configuration of their computer systems.

### SUMMARY OF THE INVENTION

One embodiment of the present invention comprises a system and method for automatically detecting devices or instruments connected to a host computer system and obtaining and installing driver software for the devices or instruments. In one embodiment, traditional instruments, e.g., an oscilloscope, connected to the host computer system via an external bus may be detected, and driver software for these traditional instruments may be obtained and installed. The method may include obtaining and installing driver software updates when a driver software update for a connected device becomes available. The method may also include automatically detecting particular software applications installed on the host computer system and obtaining and installing driver software intended for use with the installed software applications.

Another embodiment of the present invention comprises a system and method for automatically detecting devices connected to a host computer system and/or detecting software applications installed on the host computer system and automatically obtaining documentation related to the connected devices and installed software applications. For example, this documentation may include one or more of: example programs illustrating how to use an installed software application to interact with a connected device; tutorials explaining how to use an installed software application and/or a connected device; white papers with detailed information on one or more aspects of an installed software application and/or a connected device; uniform resource locators (URLs) referencing documentation related to one or more of the applications or devices, e.g., documentation stored at a website; contact information for experts, e.g., application engineers, able to provide help or answer questions regarding one or more of the applications or devices; or any of various other types of documentation related to the connected devices and/or installed software applications.

Any of various types of devices may be connected to the host computer system, e.g., devices related to an instrumentation application, test and measurement application, industrial automation application, machine vision application, etc. Examples of such devices include: oscilloscopes, waveform digitizers/analyzers, digital stimulus/response testers, pulse and pattern generators, digital I/O modules, data acquisition devices or cards, image acquisition cards, motion control cards, etc. The devices may include devices connected to the host computer system via an internal bus, e.g., a card installed in an expansion slot, as well as devices connected to the host computer system via an external bus, such as a GPIB device, VXI device, PXI device, etc. The devices may include “traditional” or “standalone” instruments operable to interface with the host computer system, such as a standalone oscilloscope.

The devices connected to the host computer system may be detected in any of various ways, e.g., depending on the type of device. For example, detecting a GPIB device may comprise sending a query to the GPIB bus to determine the identity of the GPIB devices connected to the GPIB bus. In accordance with the IEEE 488.2 standard, each GPIB device is operable to respond to this query by returning identification information specifying the identity of the GPIB device. Other devices may be detected differently, depending on the type of device. For example, a device installed in an expansion slot of the computer system may be detected by reading information identifying the device from a system registry.

Various types of software applications related to the hardware devices may be installed on or used by the computer system. For example, these software applications may include application development environments operable to create programs that interact with the hardware devices. A wide variety of software applications are specialized for creating programs that interact with devices, e.g., to perform a test and measurement or an automation application. One example of such an application is National Instruments Corp.'s LabVIEW graphical programming development environment. Another example is National Instruments Corp.'s LabWindows/CVI development environment. Other applications related to hardware devices include prototyping environment applications, which enable users to rapidly create prototypes, such as a script comprising steps to perform a process. For example, National Instruments Corp.'s IMAQ VisionBuilder application enables users to create prototypes related to machine vision applications.

As is well known in the art, driver software is often necessary in order for a software program to communicate with a hardware instrument or device. In some cases, different software applications can use the same driver software to interact with a hardware device. In other cases, in order to communicate with a device using a particular software application, or in order to use the software application to create programs that communicate with the device, driver software intended for use with that particular software application is required. This may be due, for example, to the executable code interface, such as calling conventions, etc., between the programs created by the application and the driver software.

In other cases, a software application may utilize a higher level of abstraction which enables developers to create a program to interact with a particular device. For example, the LabWindows/CVI development environment uses “function panels,” which enable developers to create device driver function calls using a graphical user interface, to obtain help on device driver functions or parameters, etc. In a case such as this, the driver software needed for communicating with a device may include not only executable code implementing device driver functions, but also any other files used by the application development environment to create programs that interact with the device (e.g., a function panel file, in the case of LabWindows/CVI).

For the reasons described above, the methods for obtaining documentation for and installing driver software for the instruments or hardware devices connected to the host computer system may operate to not only detect the hardware devices, but may also automatically detect certain software applications installed on the computer system. For example, the methods may be operable to detect whether any of a group of applications are installed by reading information from a system registry. The group of applications that are automatically detected may include application development environment applications, as well as other types of applications, as desired. It is noted that software applications which the computer system is operable to use, but which are not installed locally on the computer system, may also be detected. For example, the computer system may use an application development environment that runs on a remote application service provider.

Once the hardware devices and software applications have been detected, the methods may proceed in any of various ways to obtain the appropriate driver software and/or documentation. In the preferred embodiment, information identifying the hardware devices and software applications is sent to a computer server, which is operable to return the driver software and/or documentation. For example, the computer server may use the information to obtain the driver software and/or documentation from a database. The computer server may also lookup information specifying locations of the driver software and/or documentation from a database, and may then return the files referenced by these locations. Alternatively, location information may be returned to the host computer, e.g., as one or more URLs, and the host computer may then obtain the referenced driver software and/or documentation, e.g., by connecting to a different computer server.

With respect to the method for obtaining driver software, the method may be operable to obtain driver software for new devices connected to the computer, as well as driver software updates for existing devices. For example, in addition to sending information identifying the hardware devices and software applications to the computer server, information regarding existing driver software may also be sent, such as date/time information of the driver files or other information, e.g., from the system registry. The computer server may then be operable to use this information to determine whether an update is available for the driver software.

Once the new or updated driver software is received, the method preferably operates to automatically install the driver software. This may include extracting or decompressing files, copying various files to appropriate locations in the file system, setting registry information, etc.

With respect to the method for obtaining documentation, once the documentation or documentation locations are received, the method may proceed in various ways. For example, a user interface displaying a list of the documents along with a brief description of the documents may be displayed. The method may be operable to display a document, in response to the user selecting the document. The method may also be operable to persistently store the documents or document locations, e.g., to enable the user to view the documentation at a later time. For example, the method may add URLs referencing the documents to a list of favorites or bookmarks accessible from a web browser.

The methods described above may operate at various times or in response to various events or conditions, as desired. In one embodiment, the methods operate under control of a software application referred to herein as a Measurement and Automation Explorer. The Measurement and Automation Explorer is operable to manage instrumentation devices connected to the computer, e.g., by enabling the user to interactively control these devices. In another embodiment, the methods may operate under control of an application development environment, such as those described above.

A software application may perform the methods, for example, in response to a user selecting a menu option. The methods may also be performed at startup time, at periodic intervals, in response to receiving a notification from the operating system that a new device has been connected to the computer, etc. If the methods are performed in response to some event other than user input, the user may be notified, e.g., by displaying a dialog box enabling the user to cancel installation of the driver software.

In one embodiment, the user may specify the devices and/or software applications for which to obtain driver software and/or documentation. For example, a user interface may be displayed which enables the user to specify a combination of devices and software applications. This may be useful, for example, if multiple devices are connected to the computer system, but the user wants to obtain documentation related to one particular device. The user may also specify the types of documentation the user wants to receive.

### BRIEF DESCRIPTION OF THE DRAWINGS

A better understanding of the present invention can be obtained when the following detailed description of the preferred embodiment is considered in conjunction with the following drawings, in which:

FIGS. 1A and 1B illustrate representative instrumentation and process control systems including various I/O interface options;

FIG. 2 is a block diagram of the computer system of FIGS. 1A and 1B;

FIG. 3 is a block diagram illustrating that different software applications may use different driver software associated with the same instrument or device;

FIG. 4 illustrates a client computer system connected through a network to a server computer system;

FIG. 5 illustrates one embodiment of the server computer system shown in FIG. 4, in which the server computer system interfaces with a database;

FIG. 6 is a flowchart diagram illustrating one embodiment of a method for automatically obtaining and installing driver software related to hardware devices connected to a computer and/or software applications installed on the computer;

FIG. 7 illustrates one embodiment of a method for detecting devices or instruments connected to a computer via an external bus;

FIG. 8 is a flowchart diagram illustrating one embodiment of a method for automatically documentation related to hardware devices connected to a computer and/or software applications installed on the computer; and

FIG. 9 illustrates an exemplary hardware and software configuration.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

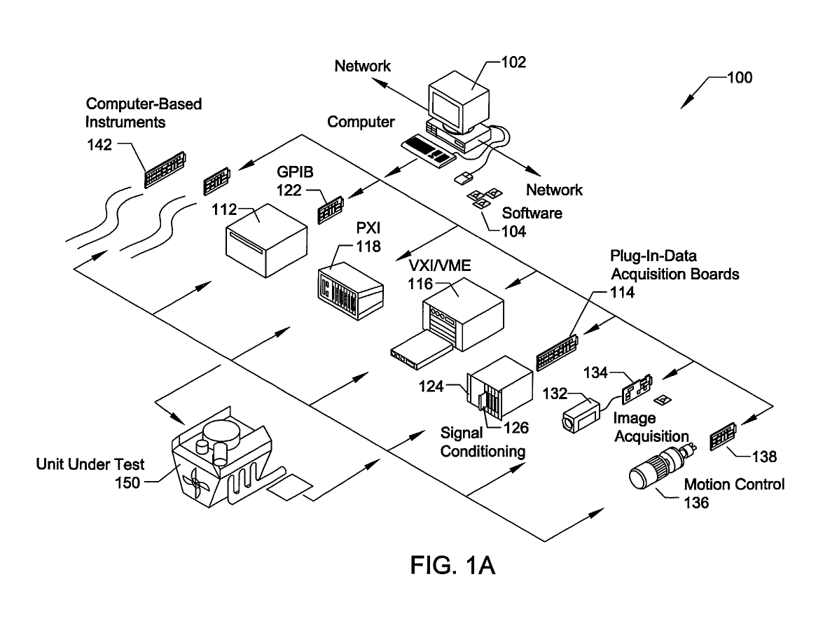

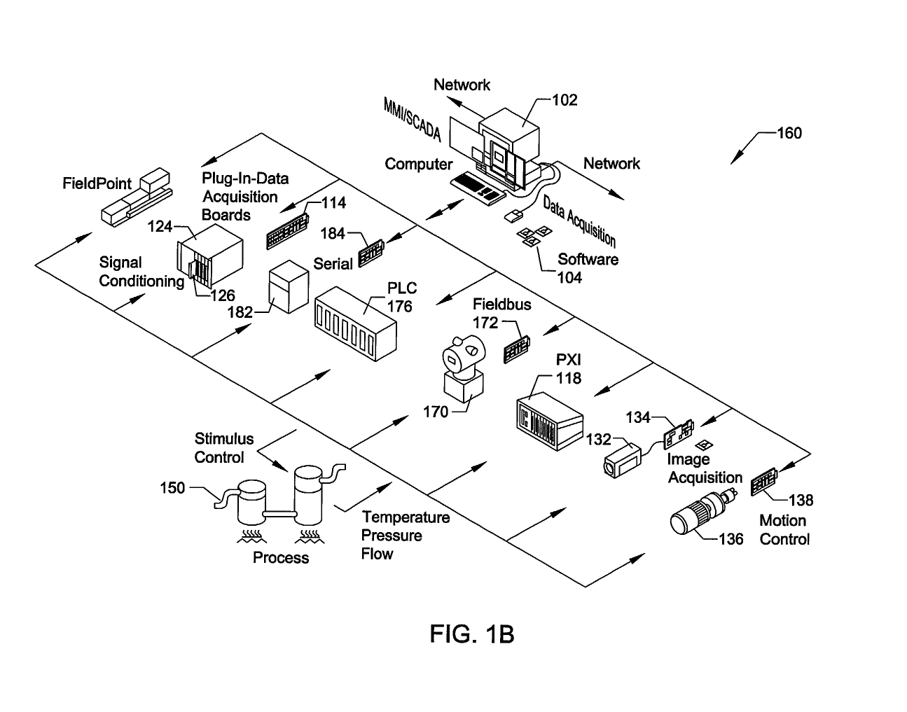

FIGS. 1A and 1B—Instrumentation and Industrial Automation Systems

FIGS. 1A and 1B illustrate exemplary systems having various types of instruments or hardware devices connected. These systems may also store or use software applications operable to interact with the hardware devices or create programs that interact with the hardware devices. These systems may also store or use software operable to automatically detect the hardware devices connected to the computer system and detect various software applications installed on the computer system and to obtain documentation related to and/or obtain and install driver software related to the connected hardware devices and installed software applications. It is noted that FIGS. 1A and 1B are exemplary only, and in alternative embodiments, any of various types of systems connecting to or including any of various types of devices may be used.

FIG. 1A illustrates an instrumentation control system 100. The system 100 comprises a host computer 102 which connects to one or more instruments. The host computer 102 comprises a CPU, a display screen, memory, and one or more input devices such as a mouse or keyboard as shown. The computer 102 connects through the one or more instruments to analyze, measure, or control a unit under test (UUT) or process 150.

The one or more instruments may include a GPIB instrument 112 and associated GPIB interface card 122, a data acquisition board 114 and associated signal conditioning circuitry 124, a VXI instrument 116, a PXI instrument 118, a video device 132 and associated image acquisition card 134, a motion control device 136 and associated motion control interface card 138, and/or one or more computer based instrument cards 142, among other types of devices.

The GPIB instrument 112 is coupled to the computer 102 via the GPIB interface card 122 provided by the computer 102. In a similar manner, the video device 132 is coupled to the computer 102 via the image acquisition card 134, and the motion control device 136 is coupled to the computer 102 through the motion control interface card 138. The data acquisition board 114 is coupled to the computer 102, and may interface through signal conditioning circuitry 124 to the UUT. The signal conditioning circuitry 124 preferably comprises an SCXI (Signal Conditioning eXtensions for Instrumentation) chassis comprising one or more SCVI modules 126.

The GPIB card 122, the image acquisition card 134, the motion control interface card 138, and the DAQ card 114 are typically plugged in to an I/O slot in the computer 102, such as a PCI bus slot, a PC Card slot, or an ISA, EISA or MicroChannel bus slot provided by the computer 102. However, these cards 122, 134, 138 and 114 are shown external to computer 102 for illustrative purposes.

The VXI chassis or instrument 116 is coupled to the computer 102 via a VXI bus, MXI bus, or other serial or parallel bus provided by the computer 102. The computer 102 preferably includes VXI interface logic, such as a VXI, MXI or GPIB interface card (not shown), which interfaces to the VXI chassis 116. The PXI chassis or instrument is preferably coupled to the computer 102 through the computer's PCI bus.

A serial instrument (not shown) may also be coupled to the computer 102 through a serial port, such as an RS-232 port, USB (Universal Serial bus) or IEEE 1394 or 1394.2 bus, provided by the computer 102. In typical instrumentation control systems an instrument will not be present of each interface type, and in fact many systems may only have one or more instruments of a single interface type, such as only GPIB instruments.

The instruments are coupled to the unit under test (UUT) or process 150, or are coupled to receive field signals, typically generated by transducers. The system 100 may be used in a data acquisition and control application, in a test and measurement application, a process control application, or a man-machine interface application.

FIG. 1B illustrates an exemplary industrial automation system 160. The industrial automation system 160 is similar to the instrumentation or test and measurement system 100 shown in FIG. 1A. Elements which are similar or identical to elements in FIG. 1A have the same reference numerals for convenience. The system 160 comprises a computer 102 which connects to one or more devices or instruments. The computer 102 comprises a CPU, a display screen, memory, and one or more input devices such as a mouse or keyboard as shown. The computer 102 connects through the one or more devices to a process or device 150 to perform an automation function, such as MMI (Man Machine Interface), SCADA (Supervisory Control and Data Acquisition), portable or distributed data acquisition, process control, advanced analysis, or other control.

The one or more devices may include a data acquisition board 114 and associated signal conditioning circuitry 124, a PM instrument 118, a video device 132 and associated image acquisition card 134, a motion control device 136 and associated motion control interface card 138, a fieldbus device 170 and associated fieldbus interface card 172, a PLC (Programmable Logic Controller) 176, a serial instrument 182 and associated serial interface card 184, or a distributed data acquisition system, such as the Fieldpoint system available from National Instruments, among other types of devices.

The DAQ card 114, the PXI chassis 118, the video device 132, and the image acquisition card 136 are preferably connected to the computer 102 as described above. The serial instrument 182 is coupled to the computer 102 through a serial interface card 184, or through a serial port, such as an RS-232 port, provided by the computer 102. The PLC 176 couples to the computer 102 through a serial port, Ethernet port, or a proprietary interface. The fieldbus interface card 172 is preferably comprised in the computer 102 and interfaces through a fieldbus network to one or more fieldbus devices. Each of the DAQ card 114, the serial card 184, the fieldbus card 172, the image acquisition card 134, and the motion control card 138 are typically plugged in to an I/O slot in the computer 102 as described above. However, these cards 114, 184, 172, 134, and 138 are shown external to computer 102 for illustrative purposes. In typical industrial automation systems a device will not be present of each interface type, and in fact many systems may only have one or more devices of a single interface type, such as only PLCs. The devices are coupled to the device or process 150.

Referring again to FIGS. 1A and 1B, the computer system 102 preferably includes a memory medium on which software operable to perform the methods of the present invention is stored. The term “memory medium” is intended to include an installation medium, e.g., a CD-ROM, floppy disks 104, or tape device, a computer system memory such as DRAM, SRAM, EDO RAM, Rambus RAM, etc., or a non-volatile memory such as a magnetic media, e.g., a hard drive, or optical storage. The memory medium may comprise other types of memory as well, or combinations thereof.

In addition, the memory medium may be located in a first computer in which the programs are executed, or may be located in a second different computer which connects to the first computer over a network, such as the Internet. In the latter instance, the second computer provides the program instructions to the first computer for execution. Also, the computer system 102 may take various forms, including a personal computer system, mainframe computer system, workstation, network appliance, Internet appliance, personal digital assistant (PDA), television system or other device. In general, the term “computer system” can be broadly defined to encompass any device having at least one processor which executes instructions from a memory medium.

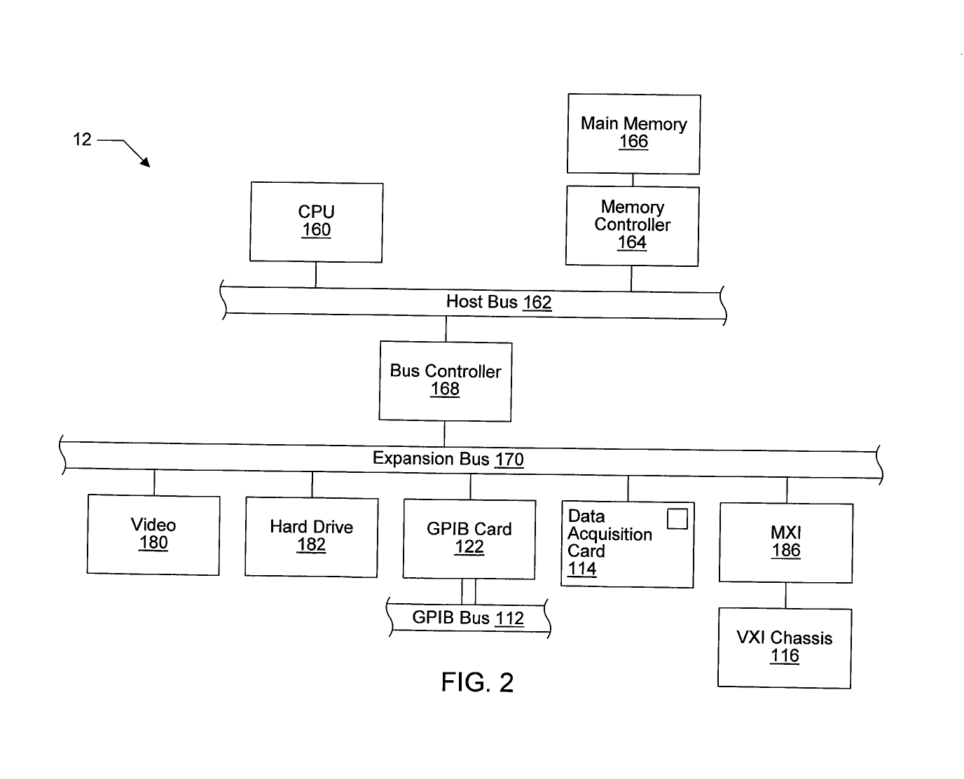

FIG. 2—Computer System Block Diagram

FIG. 2 is an exemplary block diagram of the computer systems illustrated in FIGS. 1A and 1B. It is noted that any type of computer system configuration or architecture can be used as desired, and FIG. 2 illustrates a representative PC embodiment. It is also noted that the computer system may be a general purpose computer system as shown in FIGS. 1A and 1B, a computer implemented on a VXI card installed in a VXI chassis, a computer implemented on a PXI card installed in a PXI chassis, or other types of embodiments. The elements of a computer not necessary to understand the present invention have been omitted for simplicity.

The computer 102 includes at least one central processing unit or CPU 160 which is coupled to a processor or host bus 162. The CPU 160 may be any of various types, including an x86 processor, e.g., a Pentium class, a PowerPC processor, a CPU from the SPARC family of RISC processors, as well as others. Main memory 166 is coupled to the host bus 162 by means of memory controller 164.

The main memory 166 may store software according to one embodiment of the present invention. The main memory 166 also stores operating system software as well as the software for operation of the computer system, as well known to those skilled in the art. The computer programs of the present invention will be discussed in more detail below.

The host bus 162 is coupled to an expansion or input/output bus 170 by means of a bus controller 168 or bus bridge logic. The expansion bus 170 is preferably the PCI (Peripheral Component Interconnect) expansion bus, although other bus types can be used. The expansion bus 170 includes slots for various devices such as the data acquisition board 114 (of FIG. 1A), a GPIB interface card 122 which provides a GPIB bus interface to the GPIB instrument 112 (of FIG. 1A), and a VXI or MXI bus card 186 coupled to the VXI chassis 116 for receiving VXI instruments. The computer 102 further comprises a video display subsystem 180 and hard drive 182 coupled to the expansion bus 170.

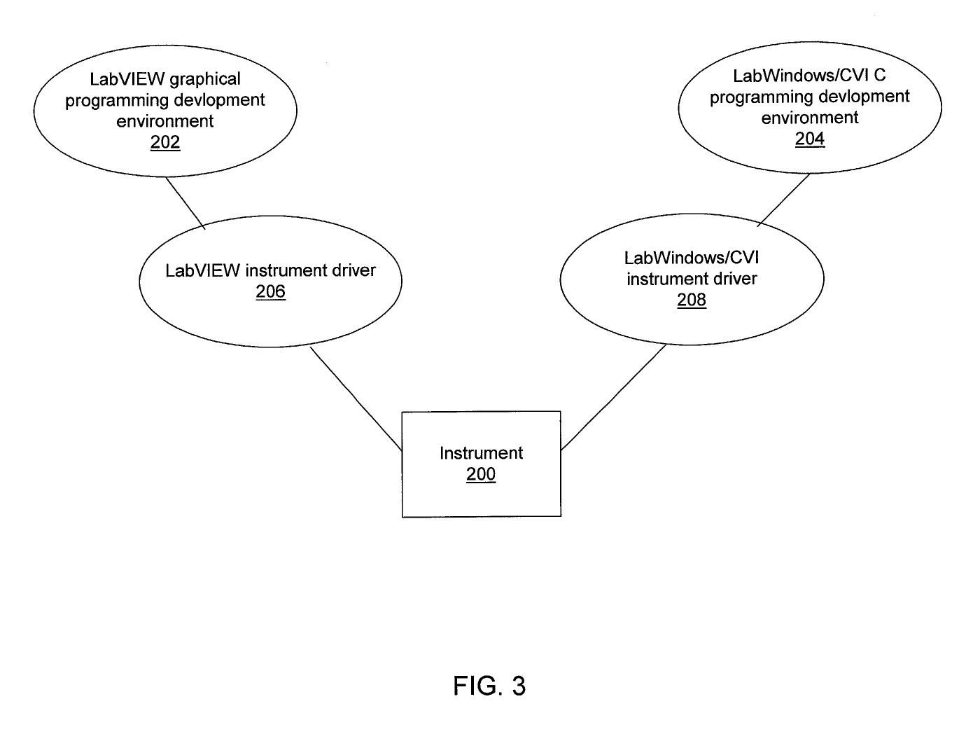

FIG. 3—Driver Software for Particular Software Applications

As described above, in addition to various hardware instruments or devices that may be connected to a host computer, the host computer may also store or use various software applications operable to interact or communicate with the hardware devices. The host computer may also store or use various software applications operable to create other applications that interact or communicate with the hardware devices. For example, various application development environments, such as LabVIEW, LabWindows/CVI, VEE, etc., may be operable to create such programs. Some of these application development environments may provide specialized support for developers of applications that interact with hardware devices or instruments. When referred to herein, an application operable to interact or communicate with the hardware devices may include application development environments such as these, as well as other types of applications. For example, in addition to creating applications that interact with the hardware devices, an application development environment may allow the user to interactively communicate with a device, e.g., to aid the user in developing an application.

As is well known in the art, driver software is often necessary in order for a software program to communicate with a hardware instrument or device. In some cases, different software applications can use the same driver software to interact with a hardware device. In other cases, in order to communicate with a device using a particular software application, or in order to use the software application to create programs that communicate with the device, driver software intended for use with that particular software application is required.

FIG. 3 is a block diagram illustrating that different software applications may use different driver software associated with the same instrument or device. FIG. 3 illustrates two exemplary software applications, the LabVIEW graphical programming development environment 202 and the LabWindows/CVI C programming development environment 204. For example, the applications 202 and 204 may be installed on or used by a computer such as the computer 102 of FIGS. 1A and 1B. Each of the applications 202 and 204 may create programs that interact with an instrument 200, e.g., a GPIB, VXI, PXI, or other instrument. However, in creating the programs, the LabVIEW application 202 may use driver software 206 specifically intended for use with LabVIEW, or the program created by the LabVIEW application 202 may use driver software 206 specifically intended for use with LabVIEW programs. Similarly, in creating the programs, the LabWindows/CVI application 204 may use driver software 208 specifically intended for use with LabWindows/CVI, or the program created by the LabWindows/CVI application 204 may use driver software 208 specifically intended for use with LabWindows/CVI programs.

There are several reasons why different software applications may use different driver software associated with the same device. For example, executable programs created by the applications may differ with respect to their interfaces to executable device driver code, e.g., the expected calling conventions, etc. Also, a software application may utilize a higher level of abstraction which aids developers in creating a program to interact with a particular device. For example, the LabWindows/CVI C programming development environment 204 uses “function panels,” which enable developers to create device driver function calls using a graphical user interface, to obtain help on device driver functions or parameters, etc. In a case such as this, the driver software needed for communicating with a device may include not only executable code implementing device driver functions, but also any other files used by the application development environment to create programs that interact with the device (e.g., a function panel file, in the case of the LabWindows/CVI application 204).

For the reasons described above, a method for obtaining and installing driver software for the instruments or hardware devices connected to the host computer system may operate to not only detect the hardware devices, but may also automatically detect certain software applications installed on the computer system, such as the applications 202 and 204 or applications created by the applications 202 and 204, e.g., in order to install driver software usable by these software applications.

Also, a method for obtaining documentation related to devices connected to the host computer system may obtain documentation related to using installed software applications, such as the applications 202 and 204, to interact with the connected devices.

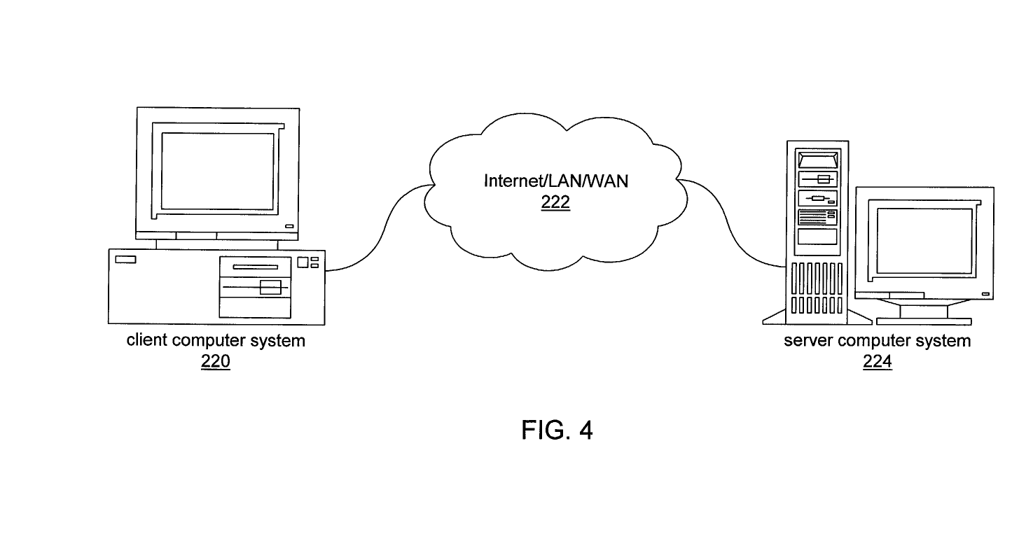

FIG. 4—Client Computer Connected to a Server Computer

FIG. 4 illustrates an exemplary computer network in which a client computer system 220 is connected through a network 222 to a server computer system 224. The client computer system 220 and the server computer system 224 can be any of various types, as desired. The network 222 can also be any of various types, including the Internet, a LAN (local area network), or a WAN (wide area network), among others.

The client computer system 220 may be operable to connect to the server computer system 224 to request driver software and/or documentation. For example, the client computer system 220 may be a computer system such as the computer system 102 described above. The client computer system 220 may connect to and download information from the server computer system using any of various techniques, e.g., through a TCP/IP connection.

When requesting driver software and/or documentation, the client computer system may pass information to the server computer system specifying hardware devices connected to and/or software applications installed on the client computer system, or a subset of this information. The server computer 224 may use this information to determine the appropriate driver software and/or documentation to return. The server computer 224 may then provide the determined driver software and/or documentation to the client computer 220.

It is noted that, in addition to (or instead of) downloading driver software and/or documentation directly from the server computer 224, the client computer system 220 may also communicate with the server computer 224 in order to determine locations of the driver software and/or documentation. For example, the server computer may provide the client computer with one or more URLs which the client computer can then reference to obtain the desired information, e.g., by connecting to another server computer system.

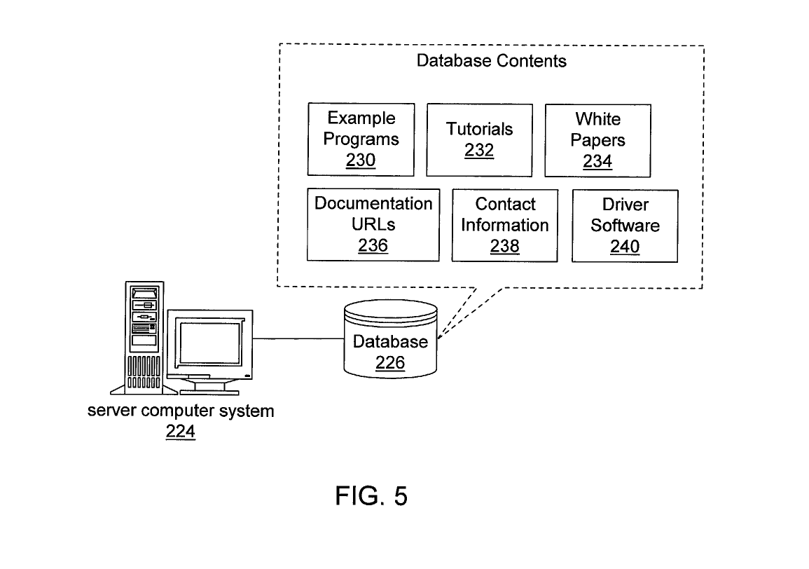

FIG. 5—Server Computer System

FIG. 5 illustrates one embodiment of the server computer system 224 shown in FIG. 4. The server computer system may interface with or maintain a database 226, e.g., in order to obtain the driver software and/or documentation requested by a client computer system. The contents of the database 226 may include any of various types of information related to hardware devices and/or software applications. The server computer may use information received from the client computer to query the database to determine the appropriate driver software and/or documentation. For example, the database may use hardware device and software application identification information as keys to classify information.

It is noted that in alternative embodiments, the server computer may interface with a plurality of databases in order to obtain the desired driver software and/or documentation. Also, the server computer may pass a request to a different server computer, which then returns the desired driver software and/or documentation to the client computer. Also, the server computer may obtain location information, e.g., URLs, from the database, and may then obtain the desired driver software and/or documentation by referencing the location information, which may involve connecting to a different computer server. Also, the server computer may return the location information to the client computer, and the client computer may reference the location information to obtain the desired driver software and/or documentation.

As shown in FIG. 5, the database 226 may include example programs 230 and tutorials 232. For example, the example programs and tutorials may illustrate how to use a particular software application, hardware device, or combination of these. The database may also include documentation such as white papers 234 or other technical documentation related to software applications/hardware devices. The database may also include information specifying URLs 236 of documentation related to software applications/hardware devices, such as documentation located on various websites. The database may also include contact information 238 indicating contact information, such as telephone numbers or email addresses for experts able to answer questions or provide help related to some combination of software applications and/or hardware devices.

Developing an application in a field such as instrumentation, test and measurement, process control, industrial automation, etc., can be a difficult task for users. Such an application may require complex hardware and/or software configuration, and there can be a steep learning curve to master the inherent complexities involved. Although documentation related to these problems may exist, it can be difficult and time-consuming for users to locate the relevant documentation. For example, the documentation may be distributed across multiple websites or may be dispersed among a vast amount of other documentation that is irrelevant to the user. Thus, automatically obtaining documentation such as described above related to the hardware and/or software configuration of the user's computer may significantly benefit the user.

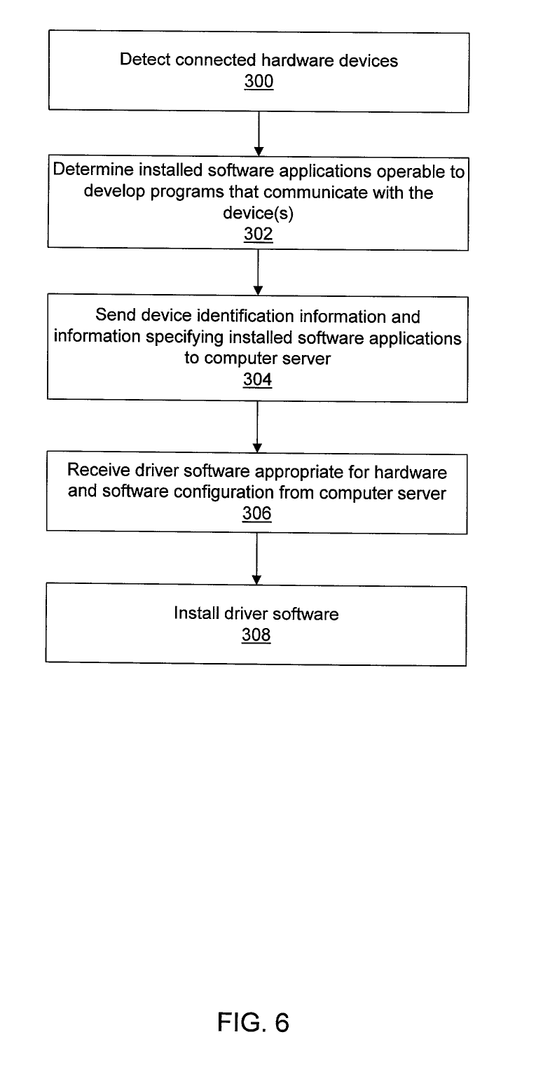

FIG. 6—Method for Obtaining and Installing Driver Software

FIG. 6 is a flowchart diagram illustrating one embodiment of a method for automatically obtaining and installing driver software. As used herein, the term “automatically” may mean that driver software is obtained and/or installed with little or no user input or other actions required of the user. For example, in one embodiment, driver software may be programmatically obtained and installed “invisibly” to the user. In various other embodiments, the user may be presented with a user interface, e.g., to inform the user of the automatic installation or to allow the user to cancel the installation.

In step 300, hardware devices or instruments connected to the computer may be detected. The devices connected to the computer may be detected in any of various ways, e.g., depending on the type of device.

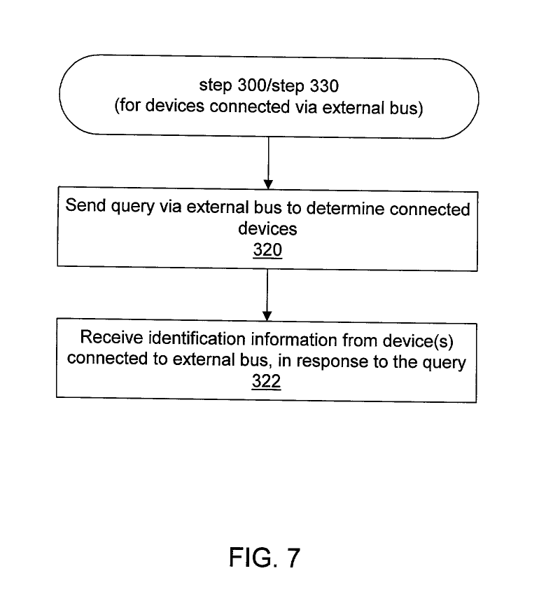

FIG. 7 illustrates one embodiment of a method for detecting devices or instruments connected to the computer via an external bus. For example, a standalone oscilloscope may be connected to the computer via a GPIB bus. In step 320 of FIG. 7, a query is sent via the external bus to determine the connected devices. In step 322, identification information is received from the device(s) connected to the external bus, in response to the query. For example, the devices may include firmware which stores an identification code or string, and the devices may be operable to retrieve and return this firmware identification information in response to receiving the query. In one embodiment, the external bus comprises a GPIB bus. In accordance with the IEEE 488.2 standard, each GPIB device connected to the bus is operable to respond to the query by returning identification information specifying the identity of the GPIB device.

Referring again to FIG. 6, step 300 may be performed in any of various other ways, e.g., depending on the type of device. For example, a device installed in an expansion slot of the computer system may be detected by reading information identifying the device from a system registry.

In step 302, installed software applications operable to communicate with the connected devices (including applications operable to create programs that communicate with the devices) may be detected. For example, the methods may detect whether any of a group of applications are installed by reading information from a system registry. The group of applications the method checks for may include applications that are known to require or use driver software. For example, the group of applications may include application development environment applications, as well as other types of applications, as desired.

It is noted that step 302 may also comprise detecting software applications which the computer system is operable to use, but which are not installed locally on the computer system. For example, the computer system may use an application development environment that runs on a remote application service provider. These types of applications may be detected in various ways, e.g., by reading registry information.

In step 304, device identification information obtained in step 300 and information specifying the installed software applications obtained in step 302 may be sent to a computer server, such as the computer server 224 shown in FIG. 5.

As described with reference to FIG. 5, the computer server 224 may be operable to analyze the information received from a client computer and determine driver software, i.e., new driver software and/or driver software updates, that would be relevant based on the hardware and software configuration. For example, as described, the computer server 224 may interface with one or more databases to obtain the driver software or location information (e.g., a URL) for the driver software. The computer server 224 may then return driver software (or location information for driver software) appropriate for the hardware and software configuration. In step 306, the driver software is received from the computer server. This driver software may include executable code usable for communicating with the connected hardware devices, and may also include other types of information, e.g., non-executable information, usable by application development environments to enable users to develop programs that communicate with the devices.

It is noted that the driver software received in step 306 may include updated driver software, e.g., to replace existing driver software, as well as new driver software. For example, in addition to the hardware device and software application identification information sent to the computer server in step 304, information regarding existing driver software may also be sent, such as date/time information of driver files, registry information regarding installed driver software, etc. The computer server may be operable to use this information to determine whether driver software updates are available.

In step 308, the driver software received in step 306 may be automatically installed. This may include extracting or decompressing files, copying various files to appropriate locations in the file system, setting registry information, etc. In one embodiment, a user interface, e.g., a dialog box, may be displayed enabling the user to specify a subset of the received driver software to install or cancel the installation.

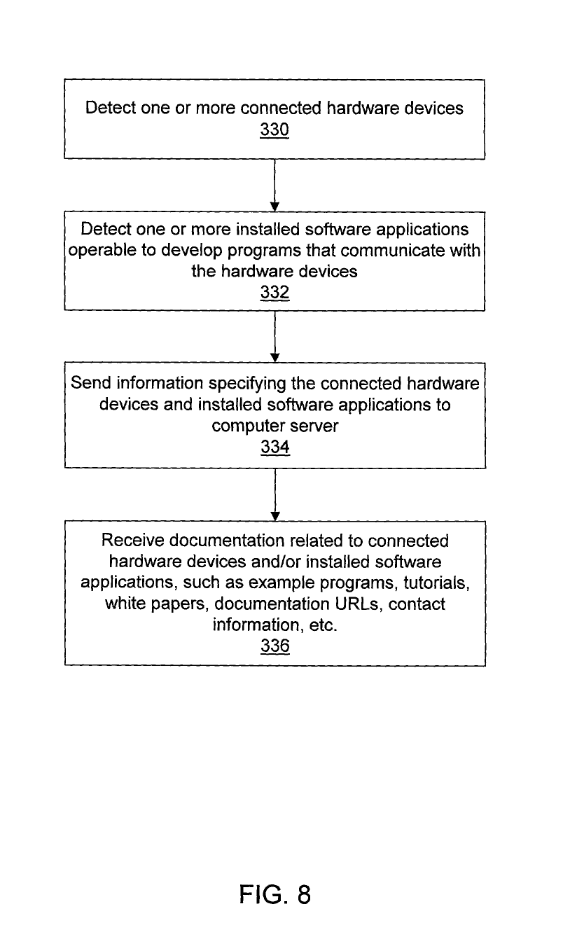

FIG. 8—Method for Obtaining Documentation for a Hardware/Software Configuration

FIG. 8 is a flowchart diagram illustrating one embodiment of a method for automatically obtaining documentation related to hardware devices connected to a computer and/or software applications installed on the computer. Similarly as described above, the term “automatically” may mean that documentation is programmatically obtained with little or no action required of the user. For example, the user may not be required to specify a search location or search terms to use in obtaining the documentation. It is noted that the methods of FIGS. 6 and 8 may be performed together.

In step 330, one or more connected hardware devices may be detected. Step 330 may be performed similarly to step 300 described above.

In step 332, one or more software applications operable to develop programs that communicate with the connected hardware devices may be detected. Step 332 may be performed similarly to step 302 described above.

In step 334, device identification information obtained in step 330 and information specifying the installed software applications obtained in step 332 may be sent to a computer server, such as the computer server 224 shown in FIG. 5. Step 334 may be performed similarly to step 304 described above. In one embodiment, a subset of the device/software identification information may be sent to the computer server. For example, the method may display a user interface enabling the user to specify a combination of devices and applications for which the user wants to receive related documentation. The user may also be able to specify types of documentation the user wants to receive. The user may also subscribe to an update service to periodically receive updated documentation.

As described above, the computer server 224 may receive and analyze the information determined in steps 330 and 332 to determine appropriate documentation based on this information. For example, as described, the computer server 224 may interface with one or more databases to obtain the documentation or location information (e.g., URLs) for the documentation. In step 336, documentation related to the identification information sent to the computer server in step 334 may be received. As described above, this documentation may include example programs, tutorials, white papers, URLs, contact information, etc.

In various embodiments, the method may present the received documentation to the user in any of various ways. For example, a window displaying icons representing received documents may be displayed, and the user may click on these icons to view the documents. The documentation may be classified or sorted in any of various ways. As noted above, URLs for the documents may be received instead of the actual documents. The method may also operate to persistently store the documents or document location information. For example, a folder for the documents may be created on the file system, or URLs referencing the documents may be added to a list of favorites or bookmarks.

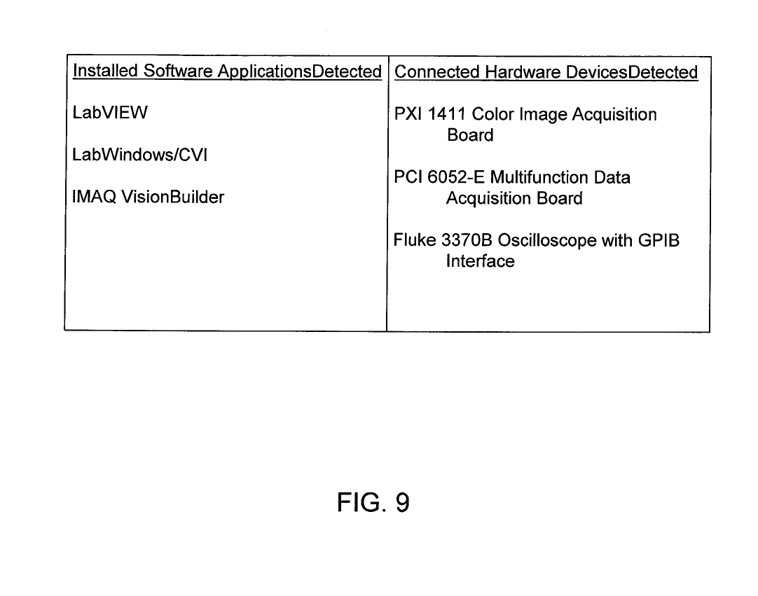

In order to better illustrate the utility of a method for automatically obtaining documentation related to a hardware and software configuration, an exemplary configuration is illustrated in FIG. 9. In this example, an image acquisition board, a data acquisition board, and an oscilloscope were detected as connected devices, and the LabVIEW, LabWindows/CVI, and IMAQ VisionBuilder applications were detected as installed software applications. Assuming that the user specified that he wanted to receive documentation related to the combination of the PCI 6052-E multifunction data acquisition (DAQ) board and the LabVIEW application, the documentation returned may include documentation such as: technical specification information for the PCI 6052-E DAQ board, a tutorial on using LabVIEW to perform data acquisition, knowledge base articles addressing specific issues of using the LabVIEW DAQ library in combination with the PCI 6052-E DAQ board, a URL to a message board regarding using LabVIEW to perform data acquisition, contact information for LabVIEW DAQ experts, etc.

The methods of FIGS. 6 and 8 may operate at various times or in response to various events or conditions, as desired. In one embodiment, the methods operate under control of a software application referred to herein as a Measurement and Automation Explorer. The Measurement and Automation Explorer is operable to manage instrumentation devices connected to the computer, e.g., by enabling the user to configure and interactively control these devices. In another embodiment, the methods may operate under control of an application development environment, such as the LabVIEW or LabWindows/CVI applications described above.

A software application may perform the methods, for example, in response to a user selecting a menu option. The methods may also be performed at startup time, at periodic intervals, in response to receiving a notification from the operating system that a new device has been connected to the computer, etc. If the methods are performed in response to some event other than user input, the user may be notified, e.g., by displaying a dialog box enabling the user to cancel installation of the driver software.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A computer-implemented method for obtaining and installing driver software on a first computer for communicating with a device, wherein the device is coupled to or comprised in the first computer, the method comprising:
automatically detecting the device coupled to or comprised in the first computer;
the first computer automatically providing identification information of the device to a computer server over a network;
the computer server determining the driver software enabling communication with the device, using the identification information;
providing the determined driver software to the first computer;
the first computer receiving the driver software for the detected device;
the first computer installing the driver software;
wherein the driver software enables communication with the device.

2. The method of claim 1, further comprising:
the computer server determining documentation regarding the device, using the identification information; and
providing the determined documentation to the first computer.

3. The method of claim 2, wherein said providing the determined documentation to the first computer comprises one or more of:
providing documentation files and information to the first computer; or
providing network locations of documentation files and information to the first computer.

4. The method of claim 1, further comprising:
automatically detecting one or more software applications installed on or used by the first computer; and
the first computer automatically providing information specifying the one or more software applications to the computer server;
wherein the computer server determines the driver software using the identification information of the device and the information specifying the one or more software applications.

5. The method of claim 4, further comprising:
the computer server determining documentation regarding the device and the one or more software applications, using the identification information of the device and the information specifying the one or more software applications; and
providing the determined documentation to the first computer.

6. The method of claim 5, wherein said providing the determined documentation to the first computer comprises one or more of:
providing documentation files and information to the first computer; or
providing network locations of documentation files and information to the first computer.

7. The method of claim 1, wherein the computer server determines the driver software by querying a database using the identification information of the device.

8. The method of claim 1, wherein the computer server provides the determined driver software to the first computer.

9. The method of claim 1, wherein the device is an instrument.

10. The method of claim 9, wherein the instrument is coupled to the first computer via an external bus, wherein the instrument is an instrument from the group consisting of:
a GPIB instrument;
a VXI instrument;
a PXI instrument; and
a serial instrument.

11. A computer-implemented method for obtaining and installing driver software on a first computer for communicating with an instrument, wherein the instrument is coupled to or comprised in the first computer, the method comprising:
automatically detecting the instrument coupled to or comprised in the first computer;
the first computer automatically providing identification information of the instrument to a computer server over a network;
the computer server determining the driver software enabling communication with the instrument, using the identification information;
the computer server providing the determined driver software to the first computer;
the first computer receiving the driver software for the detected instrument;
the first computer installing the driver software;
executing software, including the driver software, in the first computer to perform a measurement function using the instrument, wherein the driver software enables communication with the instrument.

12. The method of claim 11, further comprising:
the computer server determining documentation regarding the instrument, using the identification information; and
providing the determined documentation to the first computer.

13. The method of claim 12, wherein said providing the determined documentation to the first computer comprises one or more of:
providing documentation files and information to the first computer; or
providing network locations of documentation files and information to the first computer.

14. The method of claim 11, further comprising:
automatically detecting one or more software applications installed on or used by the first computer;
the first computer automatically providing information specifying the one or more software applications to the computer server;
wherein the computer server determines the driver software using the identification information of the instrument and the information specifying the one or more software applications.

15. The method of claim 14, further comprising:
the computer server determining documentation regarding the instrument and the one or more software applications, using the identification information of the instrument and the information specifying the one or more software applications; and
providing the determined documentation to the first computer.

16. The method of claim 11, wherein the instrument is coupled to the first computer via an external bus, wherein the instrument is an instrument from the group consisting of:
a GPIB instrument;
a VXI instrument;
a PXI instrument; and
a serial instrument.

17. A system for obtaining and installing driver software, the system comprising:
a first computer comprising a processor and memory;
a device coupled to or comprised in the first computer;
wherein the first computer requires driver software for communicating with the device;
a server computer, wherein the first computer is operable to couple to the server computer over a network;
wherein the first computer is operable to:
automatically detect the device coupled to or comprised in the first computer;
automatically provide identification information of the device to the computer server over the network;
wherein the server computer is operable to:
determine the driver software enabling communication with the device, using the identification information;
provide the determined driver software to the first computer;
wherein the first computer is operable to receive and install the driver software for the detected device, wherein the driver software enables communication with the device.

18. The system of claim 17, wherein the server computer is further operable to:
determine documentation regarding the device, using the identification information; and
provide the determined documentation to the first computer.

19. The system of claim 18, wherein said providing the determined documentation to the first computer comprises one or more of:
providing documentation files and information to the first computer; or
providing network locations of documentation files and information to the first computer.

20. The system of claim 17, wherein the first computer is further operable to:
automatically detect one or more software applications installed on or used by the first computer; and
automatically provide information specifying the one or more software applications to the computer server;
wherein the computer server is operable to determine the driver software using the identification information of the device and the information specifying the one or more software applications.

21. The system of claim 20, wherein the computer server is further operable to:
determine documentation regarding the device and the one or more software applications, using the identification information of the device and the information specifying the one or more software applications; and
provide the determined documentation to the first computer.

22. The system of claim 17, wherein the computer server determines the driver software by querying a database using the identification information of the device.

23. The system of claim 17, wherein the device is an instrument.

24. The system of claim 23, wherein the instrument is coupled to the first computer via an external bus, wherein the instrument is an instrument from the group consisting of:
a GPIB instrument;
a VXI instrument;
a PXI instrument; and
a serial instrument.

25. A system for obtaining and installing driver software, the system comprising:
a first computer comprising a processor and memory;
an instrument coupled to or comprised in the first computer;
wherein the first computer requires driver software for communicating with the instrument;
a server computer, wherein the first computer is operable to couple to the server computer over a network;
wherein the first computer is operable to:
automatically detect the instrument coupled to or comprised in the first computer;
automatically provide identification information of the instrument to the computer server over the network;
wherein the server computer is operable to:
determine the driver software enabling communication with the instrument, using the identification information;
provide the determined driver software to the first computer;
wherein the first computer is operable to:
receive and install the driver software for the detected instrument;
execute software, including the driver software, to perform a measurement function using the instrument, wherein the driver software enables communication with the instrument.

26. A method for installing driver software for an instrument, the method comprising:
automatically detecting an instrument connected to a computer via an external bus;
automatically obtaining driver software for the detected instrument;
automatically installing the driver software;
wherein the driver software enables communication with the instrument.

27. The method of claim 26, wherein the instrument is an instrument from the group consisting of:
a GPIB instrument;
a VXI instrument; and
a PXI instrument.

28. The method of claim 26, wherein said automatically detecting the instrument connected to the computer via the external bus comprises:
receiving identification information from the instrument, wherein the identification information identifies the instrument.

29. The method of claim 28, the method further comprising:
sending the identification information received from the instrument to the computer server;
the computer server determining the driver software enabling communication with the instrument, using the identification information.
wherein said automatically obtaining driver software for the detected instrument comprises receiving the driver software from the computer server,

30. The method of claim 29,
wherein said using the identification information to determine the driver software enabling communication with the instrument comprises determining the driver software from a database, based on the identification information.

31. The method of claim 28, further comprising:
querying the instrument to determine the identity of the instrument;
wherein said receiving identification information from the instrument occurs in response to said querying.

32. The method of claim 31, wherein said querying the instrument comprises sending a query request via the external bus.

33. The method of claim 26, the method further comprising:
automatically detecting a software application installed on the computer;
sending information specifying the software application to the computer server; and
the computer server determining driver software which the software application can use to communicate with the instrument, using the information specifying the software application;
wherein said automatically obtaining driver software for the detected instrument comprises receiving the driver software from the computer server.

34. The method of claim 26,
wherein driver software enabling communication with the instrument is already installed on the computer;
wherein said obtaining and installing driver software comprises obtaining and installing updated driver software for the instrument.

35. A method for installing driver software for a GPIB instrument, the method comprising:
automatically detecting a GPIB instrument connected to a computer via a GPIB bus;
automatically obtaining driver software for the detected GPIB instrument;
automatically installing the driver software;
wherein the driver software enables communication with the GPIB instrument.

36. A method for automatically obtaining documentation related to a computer system configuration, the method comprising:
automatically detecting one or more hardware devices connected to the computer system;
automatically sending information specifying the one or more hardware devices to a computer server;
receiving documentation related to the one or more hardware devices, in response to sending the information specifying the one or more hardware devices to the computer server.

37. The method of claim 36, wherein the documentation related to the one or more hardware devices includes one or more of:
an example program operable to communicate with at least one of the hardware devices;
a tutorial including explanatory information related to at least one of the hardware devices;
a white paper including information related to at least one of the hardware devices; and
contact information for experts able to provide help for at least one of the hardware devices.

38. The method of claim 36,
wherein the documentation related to the one or more hardware devices comprises a list of uniform resource locators (URLs) that reference documentation related to the one or more hardware devices.

39. The method of claim 36, further comprising:
detecting a software application installed on the computer system;
sending information specifying the installed software application to the computer server;
wherein said receiving documentation comprises receiving documentation related to using the installed software application to interact with at least one of the hardware devices.

40. The method of claim 39, wherein the documentation related to using the installed software application to interact with at least one of the hardware devices includes an example program operable to run within the software application.

41. The method of claim 36, further comprising:
detecting a plurality of software applications installed on the computer system;
receiving user input specifying a subset of the hardware devices and software applications;
sending information specifying the subset of hardware devices and software applications to the computer server;
receiving documentation related to the subset of hardware devices and software applications.

42. The method of claim 36, further comprising:
receiving user input specifying one or more types of documentation;
sending information specifying the one or more types of documentation along with the information specifying the one or more hardware devices to the computer server;
wherein said receiving documentation related to the one or more hardware devices comprises receiving documentation of the specified one or more types.

43. The method of claim 36, further comprising:
displaying the received documentation.
